(19) United States
(12) Patent Application Publication
(10) Pub. No.: US 2024/0354857 A1
(43) Pub. Date: Oct. 24, 2024

(54) PROCESS FOR INVESTING GRANT MONEY

(71) Applicant: Majdi Abou Najm, Davis, CA (US)

(72) Inventor: Karim Abou Najm, Davis, CA (US)

(21) Appl. No.: 18/625,013

(22) Filed: Apr. 2, 2024

Related U.S. Application Data
(60) Provisional application No. 63/496,872, filed on Apr. 18, 2023.

(51) Int. Cl. G06Q 40/06

(52) U.S. Cl. CPC G06Q 40/06

(57) ABSTRACT

Provided herein is a platform and method for receiving grant money from an investigator, investing the grant money, and paying the proceeds of the investment to a payee who completes a project for the investigator. The invention makes possible the investment of otherwise non-investable money before payment to said payee and avoids losses due to inflation.

### CROSS-REFERENCE TO RELATED APPLICATIONS

The application claims priority to, and the benefit of, U.S. Provisional Patent Application 63/496,872, filed Apr. 18, 2023, the entire contents of which are herein incorporated by reference in its entirety for all purposes.

### FIELD

The present disclosure concerns the field of commerce conducted in an investigator-payee environment. Specifically, the invention relates to investing money which is supposed to be stagnant.

### BACKGROUND

Work projects are posted on platforms, such as websites, by entities or individuals to find someone qualified to complete them. A platform would receive money granted for a project and hold the money until the completion of the project and the paying of the someone who completed the project. However, the completion of a project often takes months or years. During this period, grant money held in a platform's security account remains stagnant (non-transferable or inalienable). As such, grant money may lose value on account of inflation. The value loss caused by inflation is especially high when the sum of grant money is high and when inflation rate is high.

What is needed in the relevant field is processes for preventing the potential value loss caused by stagnant grant money before payment.

### SUMMARY

In an embodiment, set forth herein is a process for investing grant money, comprising: receiving grant money and a project from an investigator; identifying a payee who is due the grant money after completion of the project; receiving an agreement from the payee to either: receive the grant money; or investing the grant money; and paying the payee the grant money plus a value addition or minus a value loss; investing the grant money prior to paying the payee, wherein the investing creates a value addition or a value loss; and paying the payee: the grant money; the grant money plus the value addition; or. the grant money minus the value loss.

### BRIEF DESCRIPTIONS OF THE DRAWINGS

FIG. 1 is a flowchart of an exemplary method for processing grant money in accordance with the disclosure herein.

FIG. 2 is a flowchart of another exemplary method for processing grant money in accordance with the disclosure herein.

FIG. 3 is a flowchart of exemplary steps taken by a platform prior to investing or holding a payee's grant money.

### DETAILED DESCRIPTION

### A. Definitions

An investigator is a person or organization that has grant money available to complete projects for the person or organization. Examples of an investigator include private companies, medical institutions, software engineering companies, business associations, individuals, Principal Investigators, academic institutions, universities, laboratories, etc.

As used herein, “grant money” includes money given from one person or organization to another person or organization so that the other person or organization can spend the money in accordance with some terms communicated between the giver and receiver of funds

A platform may include a software-based platform with a secure account. Examples of platforms include Uber, AirBnB, DoorDash, eBay, Amazon Marketplace, Kickstarter, UpWork, Munchery, Heal, Canvas, Facebook, WeChat, Uber Eats, Weee, etc.

A project is a specific task in exchange for a specific amount of money. Examples of a project include a research project, an art project, an engineering project, a construction project, a design project, an administrative project, a computer software development project, an equipment or system installation project, a new product development project, a business project, a service project, a social project, an educational project, a community project, a scientific project, etc.

A payee is a person, a team, or an organization that may complete the project. Examples of a payee include students, researchers, scientists, engineers, artists, specialists, lawyers, physicians, writers, repairmen, professors, mechanics, gardeners, architects, carpenters, technicians, photographers, housekeepers, pilots, businessmen, teachers, research groups, etc.

A mutual fund is a form of collective investment scheme based upon contractual law rather than being enacted through a trust, corporation or insurance policy. Examples of a mutual fund include the Fonds commun de placement common in France and Luxembourg, the common contractual fund in Ireland,

An investment with a predetermined range of expected profit and loss potential may be an investment in funds where the payout and range of potential losses and wins will be calculated by quantitatively assessing the market based on the trading history of strategies.

### B. Process Embodiments

In an embodiment, set forth herein is a process for investing grant money, comprising: receiving grant money and a project from an investigator; identifying a payee who is due the grant money after completion of the project; receiving an agreement from the payee to either: receive the grant money; or invest the grant money; and paying the payee the grant money plus a value addition or minus a value loss; investing the grant money prior to paying the payee, wherein the investing creates a value addition or a value loss; and paying the payee: the grant money; the grant money plus the value addition; or the grant money minus the value loss.

In some examples, including any of the foregoing, further comprising, prior to the step of identifying a payee who is due the grant money after completion of a project, posting on a platform a contract which details terms of completion and an amount for the grant money. In some examples, the posting includes using a website. In some examples, the posting includes sending emails to platform users. In some examples, the posting includes sending text messages to platform users.

In some examples, including any of the foregoing, payee is an independent contractor. In certain examples, the payee is a student. In certain examples, the payee is a software engineer.

In some examples, including any of the foregoing, identifying a payee who is due the grant money after completion of a project comprises receiving an application from a payee to complete a project and approving the payee to complete the project. In certain examples, the application is filled out on the platform's website. In other examples, the application is mailed, emailed, or uploaded to the platform.

In some examples, including any of the foregoing, investing the grant money prior to paying the payee comprises investing the grant money in a mutual fund.

In some examples, including any of the foregoing, investing the grant money prior to paying the payee comprises investing the grant money in a high frequency trading fund, wherein the high frequency trading fund can apply an automatic trading strategy that uses algorithms and powerful computers to make instantaneous trades independent of direct human supervision.

In some examples, including any of the foregoing, investing the grant money prior to paying the payee comprises investing the grant money for 1 day.

In some examples, including any of the foregoing, investing the grant money prior to paying the payee comprises investing the grant money for 1 week.

In some examples, including any of the foregoing, investing the grant money prior to paying the payee comprises investing the grant money for 1 month.

In some examples, including any of the foregoing, investing the grant money prior to paying the payee comprises investing the grant money for 1 year.

In some examples, including any of the foregoing, investing the grant money prior to paying the payee comprises investing the grant money in multiple investments.

In some examples, including any of the foregoing, investing the grant money prior to paying the payee comprises investing in an investment with a predetermined range of expected profit and loss potential.

In some examples, including any of the foregoing, the investment with a predetermined range of expected profit and loss potential is an investment with 10% expected profit and 10% loss potential.

In some examples, including any of the foregoing, the investment with a predetermined range of expected profit and loss potential is an investment with 5% expected profit and 5% loss potential.

In some examples, including any of the foregoing, the investment with a predetermined range of expected profit and loss potential is an investment with 6% expected profit and 3% loss potential.

In some examples, including any of the foregoing, the investment with a predetermined range of expected profit and loss potential is an investment with 7% expected profit and 9% loss potential.

In some examples, the process includes receiving an agreement from a payee, wherein receiving the agreement comprises receiving permission from the payee to invest in an investment with a predetermined range of expected profit and loss potential. In some examples, the agreement is received by having the payee fill out an online consent form.

In some examples, the expected profit and loss potential may be quantitatively calculated based on the performance of the fund and positions taken in the funds. In some examples, the expected profit is high and loss potential is low because the trading history of the fund shows that the profit of the fund was high and the loss of the fund was low. In some examples, the expected profit is low and loss potential is high because the trading history of the fund shows that the fund lost more often than profited.

In some examples, the process includes any of the foregoing, receiving an agreement from a payee, wherein receiving the agreement comprises receiving permission from the payee to invest in a mutual fund.

In some examples, in the agreement, the mutual fund may show expected profit, loss potential, trading history of strategies, etc.

In some examples, the agreement may show that when the profit exceeds the expected profit, all additional profits are assigned to the mutual fund owners or to the payee, or the additional profits are divided and then assigned respectively to the mutual fund owners and the payee.

In some examples, the agreement includes a stipulation covering the situation when the loss exceeds the loss potential. In some examples, the stipulation may include a minimum payment to the payee. In some of these examples, according to the agreement, the minimum payment is the grant money. In some of these examples, according to the agreement, the minimum payment is half the grant money. In some of these examples, according to the agreement, the minimum payment is a certain percentage of the grant money.

In some examples, including any of the foregoing, the process includes investing with an expected profit.

In some examples, the process includes investing with an expected loss.

In some examples, the expected profit and loss potential may be quantitatively calculated based on the performance of the fund and positions taken in the funds. For example, one mutual fund may have 10% expected profit and 10% loss potential while another mutual fund may have 5% expected profit and 5% loss potential. If the payee prefers a risky investment, the payee may choose to invest the grant money into the former mutual fund. If the payee prefers a stable investment, the payee may choose to invest the grant money into the latter mutual fund. In some examples, a payee may choose to put a portion of the grant money into a risky fund and a portion of the money into stable investment.

In some examples, the potential loss may be 10%. In some examples, the potential loss may be 9%. In some examples, the potential loss may be 8%. In some examples, the potential loss may be 7%. In some examples, the potential loss may be 6%. In some examples, the potential loss may be 5%. In some examples, the potential loss may be 4%. In some examples, the potential loss may be 3%. In some examples, the potential loss may be 2%. In some examples, the potential loss may be 1%.

In some examples, the expected profit may be 10%. In some examples, the expected profit may be 9%. In some examples, the expected profit may be 8%. In some examples, the expected profit may be 7%. In some examples, the expected profit may be 6%. In some examples, the expected profit may be 5%. In some examples, the expected profit may be 4%. In some examples, the expected profit may be 3%. In some examples, the expected profit may be 2%. In some examples, the expected profit may be 1%.

In some examples, the process comprises receiving from the investigator details of condition of completion of the project and the amount of the grant money to be paid upon completion of the project.

In some examples, the process comprises receiving from the investigator the grant money after posting the project.

In some examples, the receiving from the investigator the grant money may be accomplished via a bank transfer. In some examples, the receiving from the investigator the grant money may be accomplished via an electronic funds transfer, such as direct deposit. In some examples, the receiving from the investigator the grant money may be accomplished via a wire transfer. In some examples, the receiving from the investigator the grant money may be accomplished via a money order. In some examples, the receiving from the investigator the grant money may be accomplished via a cash transfer.

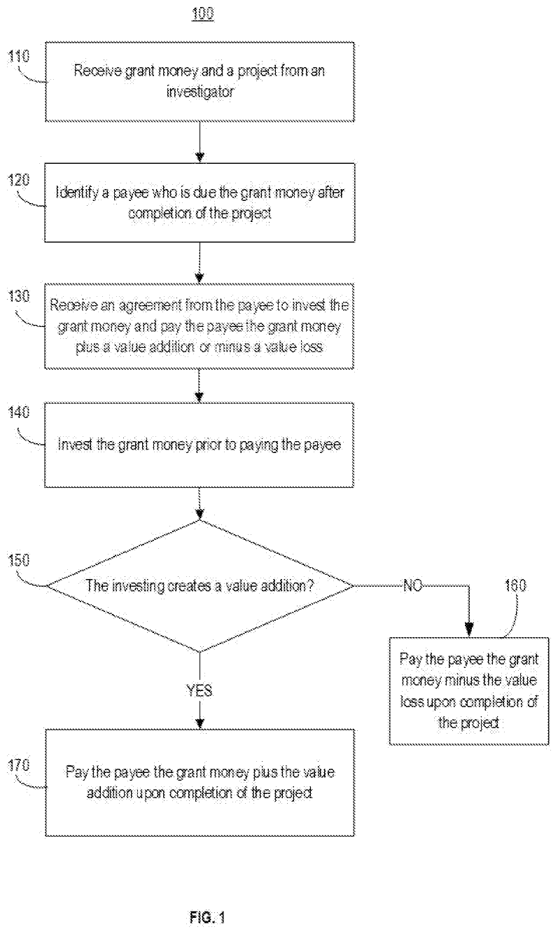

As shown in FIG. 1, in one example, the process includes the following steps. Step 110 is receiving grant money and a project from an investigator. Step 120 is identifying a payee who is due the grant money after completion of the project. Step 130 is receiving an agreement from the payee to invest the grant money and paying the payee the grant money plus a value addition. Step 140 is investing the grant money prior to paying the payee. Step 150 is determining whether the investing creates a value addition. If not, the next step is step 160, which is paying the payee the grant money minus the value loss upon completion of the project. If so, the next step is step 170, which is paying the payee the grant money plus the value addition upon completion of the project.

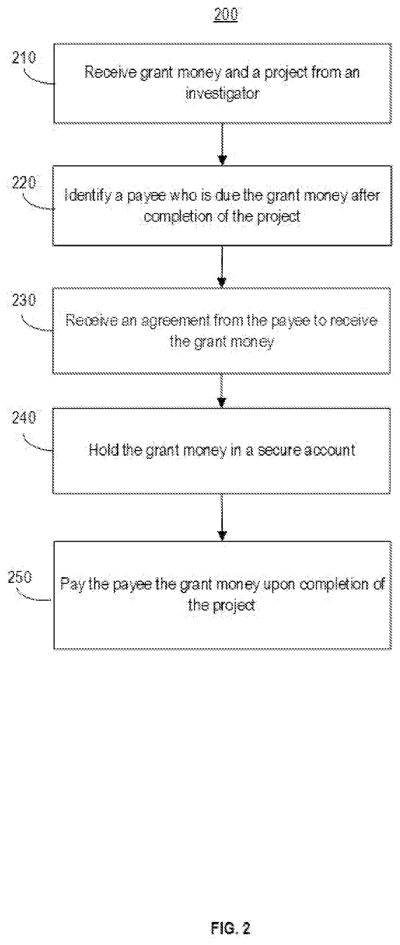

As shown in FIG. 2, in one example, the process includes the following steps. Step 210 is receiving grant money and a project from an investigator. Step 220 is identifying a payee who is due the grant money after completion of the project. Step 230 is receiving an agreement from the payee to receive the grant money. Step 240 is holding the grant money in a secure account. Step 250 is paying the payee the grant money upon completion of the project. In some examples, after Step 220 and before Step 230, there may be another step which is Step 225 where the payee rejects the option to invest the grant money. In some examples, the payee may not be provided with an option to invest the grant money.

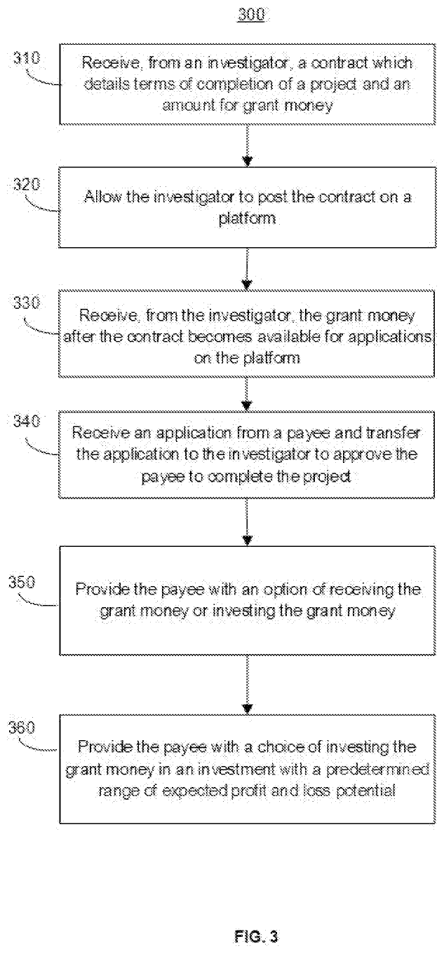

As shown in FIG. 3, in one example, the process includes the following steps. Step 310 is receiving, from an investigator, a contract which details terms of completion of a project and an amount for grant money. Step 320 is allowing the investigator to post the contract on a platform. Step 330 is receiving, from the investigator, the grant money after the contract becomes available for applicants on the platform. Step 340 is receiving an application from a payee and transferring the application to the investigator to approve the payee to complete the project. Step 350 is providing the payee with an option of receiving the grant money or investing the grant money. Step 360 is providing the payee with a choice of investing the grant money in an investment with a predetermined range of expected profit and loss potential.

### EXAMPLES

### Example 1—Prophetic

This Example shows that the processes for investing grant money, disclosed herein, can invest the otherwise stagnant grant money to make profits when a payee chooses to invest the grant money.

Step one: The platform would receive grant money and a project from an investigator. The grant money would be $1,000. The project would be writing a smartphone app that counts the days in a year. The investigator would be a university professor at UC Davis.

Step two: The platform would receive from the professor an email that includes a contract with details of the smartphone app project and the $1,000 to be paid for completion of the app. Step three: The platform would allow the professor to post the contract on the platform.

Step four: The platform would receive from the professor the grant money, $1,000, via a bank transfer after the contract is available for applications on the platform.

Step five: The platform would receive applications from people who would like to write the smartphone app for the professor.

Step six: The platform would transfer the applications received to the professor so that the professor would identify a qualified candidate as a payee and approve the payee to complete the project.

Step seven: When the payee is accepted to the contract, the platform would offer the payee two options: receive the grant money in full or invest the grant money.

Step eight: When the payee would choose to invest the grant money, the payee would, in an agreement, permit the platform to invest the grant money, $1,000, into a mutual fund handled by a third party, wherein the payee would choose to invest the $1,000 into a mutual fund that would have 10% expected profit and 10% loss potential because the payee would prefer a High-Risk/High Reward investment.

Step nine: The platform would invest the $1,000 into the fund that has 10% expected profit and 10% loss potential, wherein the fund finally would make a 5% value addition upon completion of the project.

Step ten: The platform would pay the payee the grant money plus the value addition which would be $1,050 rather than $1000.

### Example 2—Prophetic

This Example shows that grant money potentially loses value due to inflation if not used in accordance with the inventions disclosed herein. For example, without the process for investing grant money disclosed here, grant money would be non-transferable and would potentially lose value to inflation

A professor would be looking for a person to complete a project. The professor would have grant money of $1000.

The professor would not use a process for investing grant money disclosed herein. After the professor identified a qualified person to complete the project, it took the person two years to complete the project.

Due to inflation of 7% in 2021, and 1.23% 2020, the grant money lost 8.1439% of its value upon completion of the project. The value of the grant money decreased from $1000 to $918.561 before it could be spent.

The embodiments and examples described above are intended to be merely illustrative and non-limiting. Those skilled in the art will recognize or will be able to ascertain using no more than routine experimentation, numerous equivalents of specific compounds, materials and procedures. All such equivalents are considered to be within the scope and are encompassed by the appended claims.

What is claimed is:

1. A process for investing grant money, comprising:
a. receiving grant money and a project from an investigator;
b. identifying a payee who is due the grant money after completion of the project;
c. receiving an agreement from the payee to either:
i. receive the grant money; or
ii. invest the grant money; and pay the payee the grant money plus a value addition or minus a value loss;
d. investing the grant money prior to paying the payee, wherein the investing creates a value addition or a value loss;
e. and paying the payee:
i. the grant money;
ii. the grant money plus the value addition; or
iii. the grant money minus the value loss.

2. The process of claim 1, further comprising, prior to the step of identifying a payee who is due the grant money after completion of a project, posting on a platform a contract which details terms of completion and an amount for the grant money.

3. The process of claim 1, wherein the payee is an independent contractor.

4. The process of claim 1, wherein identifying a payee who is due the grant money after completion of a project comprises receiving an application from a payee to complete a project and approving the payee to complete the project.

5. The process of claim 1, wherein the investing the grant money prior to paying the payee comprises investing the grant money in a mutual fund.

6. The process of claim 1, wherein the investing the grant money prior to paying the payee comprises investing in an investment with a predetermined range of expected profit and loss potential.

7. The process of claim 1, wherein the receiving an agreement from a payee comprises receiving permission from the payee to invest in an investment with a predetermined range of expected profit and loss potential.

8. The process of claim 1, wherein the receiving an agreement from a payee comprises receiving permission from the payee to invest in a mutual fund.

9. The process of claim 1, wherein the investing has an expected profit.

10. The process of claim 1, wherein the investing has an expected loss.

11. The process of claim 1, wherein the process comprises receiving from the investigator details of condition of completion of the project and the amount of the grant money to be paid upon completion of the project.

12. The process of claim 1, wherein the process comprises receiving from the investigator the grant money after posting the project.
